(19) United States
(12) Patent Application Publication
(10) Pub. No.: US 2025/0193504 A1
(43) Pub. Date: Jun. 12, 2025

(54) IMAGING DEVICE, METHODS AND AUGMENTED OR VIRTUAL REALITY DEVICE

(71) Applicant: HUIZHOU TCL MOBILE COMMUNICATION CO., LTD., Huizhou, Guangdong (CN)

(72) Inventors: Liliang WANG, Huizhou, Guangdong (CN); Yang YU, Huizhou, Guangdong (CN)

(73) Assignee: HUIZHOU TCL MOBILE COMMUNICATION CO., LTD., Huizhou, Guangdong (CN)

(21) Appl. No.: 18/847,240

(22) PCT Filed: Jan. 3, 2023
(86) PCT No.: PCT/CN2023/070029

§ 371 Date: Sep. 14, 2024

(30) Foreign Application Priority Data
Mar. 14, 2022 (CN) 202210247177.6

(51) Int. Cl. H04N 23/55; G06T 17/00

(52) U.S. Cl. CPC H04N 23/55; G06T 17/00

(57) ABSTRACT

An imaging device, a method and an augmented or virtual reality device that relates to an AR/VR technical field. The imaging device includes a lens assembly and a screen assembly. The screen assembly includes a first screen and a second screen between the first screen and the lens assembly. The screen assembly displays the image in a transmission area of the lens assembly. The image includes image units with different image distances. The imaging device can image the image unit with different image distances to the image plane at different positions, solving the technical problem that the actual imaging position and the combined image position do not coincide, and reduce the dizziness.

This application claims the priority of Chinese Patent Application No. 202210247177.6, entitled “IMAGING DEVICE, METHODS AND AUGMENTED OR VIRTUAL REALITY DEVICE”, filed on Mar. 14, 2022, the disclosure of which is incorporated herein by reference in its entirety.

### FIELD OF THE DISCLOSURE

The present disclosure relates to a field of augmented reality (AR) and virtual reality (VR) technology, specifically to an imaging device, a method and an augmented or virtual reality device.

### BACKGROUND

With the rapid development of the augmented reality (AR) and virtual reality (VR) industries, users have higher and higher requirements for product experience. On the one hand, there is a need for lighter and thinner products to reduce the burden on the head, and on the other hand, there is a need for better and better optical imaging results. The reason why AR and VR are developing so rapidly is mainly because it has a 3D display effect that traditional electronic display products do not have, through this 3D display effect, on the one hand, it can present the picture that is not easy to be presented in real life through AR and VR display, and on the other hand, it can immerse people in the virtual world constructed by the product. Therefore, the quality of 3D display effect is an important factor to measure the performance of AR and VR products, and users are also in urgent need of better 3D display effect products.

AR and VR independently input the display content of the left and right eyes, and the content of the left and right eyes simulates the image of the actual object to the left and right eyes of the person and the difference in viewing angle, so that after binocular imagery, a three-dimensional sense of space similar to the actual will be generated. However, the current AR and VR products do not coincide with the actual imaging position and the combined image position, which contradicts the feeling of the actual observation of objects by the human eye, which violates the normal habit of observing objects and makes people feel dizzy.

### Technical Problem

The embodiment of the present disclosure provides an imaging device, a method and an augmented or virtual reality device to solve the problem that the actual imaging position of the existing imaging device does not coincide with the binocular image position to cause people to produce a sense of vertigo.

### Technical Solution

In order to solve the above-mentioned technical problem, the technical solution of the present disclosure is as follows:

The embodiment of the present disclosure provides an imaging device, comprising:
a lens assembly;
a screen assembly, comprising a first screen and a second screen between the first screen and the lens assembly;
the screen assembly is configured to display an image in a transmission area of the lens assembly, where the image comprises image units with different image distances;
wherein upon a condition that the second screen is a display screen, the first screen and the second screen display the image units, and the image unit displayed by the first screen is transmitted through the second screen, or the second screen is a refractive screen, the first screen displays each image unit frame by frame, and the second screen transmits the image unit, and adjusts a refractive index of the second screen according to the image distance of the image unit.

In some embodiments, the screen assembly comprises a plurality of second screens, and each of the plurality of second screen are stacked between the first screen and the lens assembly.

In some embodiments, upon the condition that the second screen is the display screen, the image distances of the image units displayed by each of the plurality of second screen are different; the closer the second screen to the lens assembly is, the closer the image distance of the displayed image unit is.

In some embodiments, upon the condition that the second screen is the refractive screen, the refractive index of the second screen is adjusted by changing energizing state.

In some embodiments, the second screen is a TN screen.

In some embodiments, the first screen and the second screen are coaxially superimposed.

In some embodiments, the first screen and the second screen are coaxially superimposed and arranged at a focal plane position of the lens assembly.

In some embodiments, the display screen or the refractive screen is a transparent screen.

In some embodiments, the imaging device further comprises a control unit, configured to control the first screen and the second screen to display the image units upon the condition that the second screen is the display screen; or configured to control the first screen to display the image unit frame by frame, and adjust the refractive index of the second screen according to the image distance of the image unit upon the condition that the second screen is the refractive screen.

In some embodiments, the lens assembly is of an integrated structure.

In some embodiments, the lens assembly is of a split structure.

In some embodiments, the lens assembly comprises a left lens and a right lens both made by multiple lenses.

In some embodiments, the screen assembly is of an integrated structure.

Correspondingly, the embodiment of the present disclosure provides an imaging method applied to the imaging device. The method includes:
controlling the first screen and the second screen to display the image units, or controlling the first screen to display the image unit frame by frame, and synchronously adjusting the refractive index of the second screen according to the image distance of the image unit;
merging the image units displayed in the transmission area of the lens assembly to form the image.

An embodiment of the present disclosure provides an augmented or virtual reality device comprising the imaging device as stated above.

### Advantageous Effect

In contrast to the prior art, the imaging device of the embodiment of the present disclosure comprises a lens assembly and a screen assembly. The screen assembly comprises a first screen and a second screen arranged between the first screen and the lens assembly. The screen assembly is configured to display an image in a transmission area of the lens assembly, where the image comprises image units with different image distances. Upon a condition that the second screen is a display screen, the first screen and the second screen display the image units, and the image unit displayed by the first screen is transmitted through the second screen. Upon a condition that the second screen is a refractive screen, the first screen displays each image unit frame by frame, and the second screen transmits the image unit, and adjusts a refractive index of the second screen according to the image distance of the image unit.

By arranging the second screen between the first screen and the lens assembly, it can be understood that when the second screen is a display screen, the object distances of the second screen and the first screen are different, and the image distances of the second screen and the first screen are also different, so that the image units of different image distance can be imaged to the image plane of different positions, solve the technical problem that the actual imaging position and the combined image position do not coincide, and reduce the sense of vertigo. It is understandable that when the second screen is a refractive screen, by adjusting the refractive index of the second screen, the slight change of the back focal distance can be controlled, and the distance change of the imaging distance can be realized, so that the image unit of different image distances can also be imaged to the image plane of different positions, solve the technical problem that the actual imaging position and the combined image position do not coincide, and reduce the sense of vertigo. It is understood that the augmented or virtual reality equipment provided in the embodiment of the present disclosure may have all the technical features of the above-mentioned imaging device as well as beneficial effects, and will not be repeated herein.

### BRIEF DESCRIPTION OF THE DRAWINGS

In order to more clearly illustrate the technical solutions in the embodiments of the present disclosure, the drawings required to be used in the description of the embodiments will be briefly introduced below, and it is obvious that the drawings described below are only some embodiments of the present disclosure, and for those skilled in the art, other drawings can be obtained according to these drawings without creative labor.

FIG. 1 illustrates a schematic representation of the actual image of the object to the human eye.

FIG. 2 illustrates a schematic diagram of the principle that the actual imaging position and the binocular imaging position do not coincide.

FIG. 3 illustrates a schematic diagram of the structure of the imaging device according to a first embodiment of the present disclosure.

FIG. 4 illustrates a schematic diagram of the structure of the imaging device according to a second embodiment of the present disclosure.

FIG. 5 illustrates a schematic diagram of the light refraction of the second screen of the imaging device in the energized state in FIG. 4.

FIG. 6 illustrates a schematic representation of the light refraction of the second screen of the imaging device in the non-energized state in FIG. 4.

FIG. 7 illustrates a schematic diagram of the imaging process of the imaging device in FIG. 4, in which a shows the display state of the image unit of the distant scene, in the FIG. b shows the display state of the image unit of the near view, and in the FIG. c shows the display state that the eyes actually feel;

### REFERENCE SIGNS

100—binocular; 101—left eye; 102—right eye; 103—a lens assembly; 104—left lens; 105—right lens; 106—screen assembly; 107—first screen; 108—second screen; 109—object; 110—distinct view; 111—near view; 112—first imaging plane; 113—second imaging plane; 114—actual imaging surface.

### EMBODIMENT OF THE PRESENT DISCLOSURE

The technical solutions in the embodiments of the present disclosure will be clearly and completely described below in conjunction with the accompanying drawings in the embodiments of the present disclosure, and it is obvious that the described embodiments are only part of the embodiments of the present disclosure, not all embodiments. Based on the embodiments in the present disclosure, all other embodiments obtained by a person skilled in the art without creative work fall within the scope of protection of the present disclosure.

In the description of the present disclosure, it is understood that the terms “first” and “second” are used for descriptive purposes only and should not be construed as indicating or implying relative importance or implying the number of technical features indicated. Thus, defining the “first” and “second” features may explicitly or implicitly include one or more of these features. In the description of this application, “plurality” means two or more than two, unless otherwise expressly and specifically qualified.

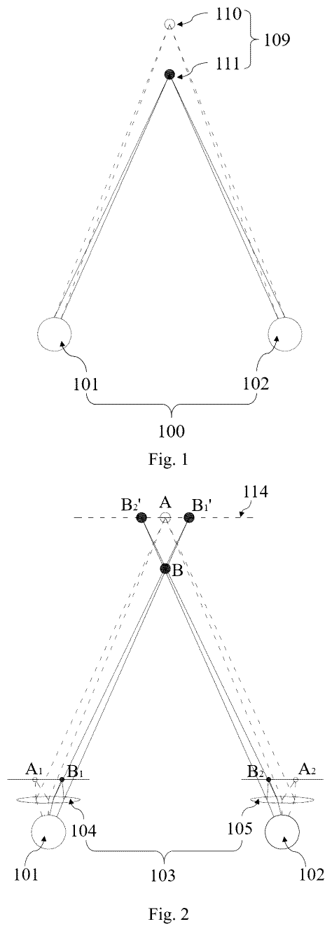

As illustrated in FIG. 1, an object 109 observed by the binocular 100 is three-dimensional because the images of the same object 109 projected in the left eye 101 and the right eye 102 are different in a certain angle of view. The difference in viewing angle makes the object 109 have a certain angle with both eyes, and the human brain combines the depth of field information of the object 109 through the opening angle information of the object 109 to the binocular 100, so that people can distinguish a distant view part 110 and a near view part 111 of the object 109 to form a three-dimensional visual experience.

However, the three-dimensional perception of space created by simulation with current AR and VR equipment is different from observing an actual object 109. As shown in FIG. 2, in the stereoscopic image formed by the current AR and VR equipment, it is assumed that the image unit of the distant view and the image unit of the near view are indicated by the two points A and B respectively, and in order to simulate the spatial distance perception, the current AR and VR device will set the relative position relationship between the two points A and B respectively in the left and right display screens, so as to simulate the angle difference of the two eyes 100. In FIGS. 2, A1 and B1 simulate the perspective of 101 points A and B of the left eye, respectively, and A2 and B2 simulate the perspective of 102 points A and B of the right eye, respectively.

According to Newton's imaging formula:

$$\frac{1}{{S}^{′}} - \frac{1}{S} = \frac{1}{f} ,$$

where S′ is an image distance indicative of a distance between the image and the optical center of the lens, S is an object distance indicative of a distance between the object and the optical center of the lens, and f is the focal length referring to a distance from the optical center of the lens to the focal point of light concentration when the parallel light is incident.

It can be seen that the same focal plane corresponds to the same image plane. Because points A1, B1, A2, and B2 are all displayed in the left and right microscopic screens of AR and VR devices, and are located in the same object plane, their actual imaging positions should also be in the same image plane (actual imaging plane 114). The points B1 and B2 located on the inner side form B1′ and B2′ on the actual imaging plane 114, so that the actual imaging position of point B does not coincide with the combined image position, and contradicts the feeling of the actual observation object of the human eye. This contradiction violates people's normal habit of observing objects and makes people feel dizzy.

Accordingly, the first embodiment of the present disclosure provides an imaging device to solve the problem.

According to the first embodiment, the imaging device comprises a lens assembly 103 and a screen assembly 106 as illustrated in FIG. 3.

The lens assembly 103 comprises a left lens 104 and a right lens 105 corresponding to the left eye 101 and the right eye 102 of a person, respectively. The lens assembly 103 can be designed as a one-piece structure, that is, the left lens 104 and the right lens 105 can be designed as a single piece. However, in order to meet the needs of different interpupillary distance use, the lens assembly 103 usually adopts a split structure. The interpupillary distance can be adjusted with the setting spacing adjustment mechanism to facilitate use. The left lens 104 and the right lens 105 can be made by multiple lenses, so that the left lens 104 and the right lens 105 can independently adjust the focal length to meet the needs of different focal lengths.

The screen assembly 106 is configured to display an image within the transmission region of the lens assembly 103. The binocular 100 can see the image through the transmission region of the lens assembly 103. It is understandable that the images displayed by the screen assembly 106 also correspond to the left eye 101 and the right eye 102, respectively, to simulate the difference in viewing angles.

Optionally, the screen assembly 106 may be a split structure which comprises a left eye screen assembly 106 corresponding to the left eye 101 and a right eye screen assembly 106 corresponding to the right eye 102. The screen assembly 106 of split structure can correspond to the lens assembly 103 of the split type, so as to facilitate the adjustment of the interpupillary distance, focal length, or angle of view of the imaging device.

Optionally, the screen assembly 106 may be an integral structure, spanning the transmission regions of the left lens 104 and the right lens 105, and displaying images of different viewing angles in the two transmission regions corresponding to the left eye 101 and the right eye 102.

Therefore, those skilled in the art may select the specific requirements of the screen assembly 106 and the lens assembly 103 according to actual needs.

The screen assembly 106 comprises a first screen 107 and a second screen 108. The second screen 108 is arranged between the first screen 107 and the lens assembly 103. In the first embodiment, the first screen 107 and the second screen 108 are display screens for displaying and image units of images. The light emitted by the first screen 107 first passes through the second screen 108, and then is imaged to its image plane position by the lens assembly 103. The light emitted by the second screen 108 is directly imaged to its image plane position through the lens assembly 103. Accordingly, the first screen 107 can adopt a conventional microscopic screen, and the second screen 108 needs to ensure that the image units displayed by the first screen 107 can be transmitted. Therefore, the second screen 108 should be transparency, and preferably, the second screen 108 is a transparent screen. The image plane is the surface that the object can be clearly imaged through the lens.

Please refer to FIG. 3. In the first embodiment, the imaging device needs to split the image into a plurality of image units with different image distances to display a stereoscopic image. In order to facilitate understanding, in this embodiment, the image is split into an image unit of a distant view and an image unit of a near view. It is assumed that the image unit of the distant view and the image unit of the near view that are split from the image are respectively represented by two points A and B in FIG. 3, and an image can be formed through the combination of two points A and B.

In the first embodiment, in order to simulate the sense of spatial distance, the imaging device sets the relative position relationship between two points A and B respectively in the left eye screen assembly 106 and the right eye screen assembly 106, so as to simulate the angle of view difference of the binocular 100. As illustrated in FIGS. 3, A1 and B1 simulate the viewing angles of the left eye 101 for A and B, respectively, and A2 and B2 simulate the viewing angles of the right eye 102 for A and B, respectively.

According to the above Newton imaging formula, for the image units A1 and A2 of the distant view, the image distance should be farther and therefore the object distance should be farther. For the image units B1 and B2 of the near view, the image distance should be closer, and thus the object distance should also be closer. Therefore, the imaging device of the present embodiment displays image units A1 and A2 in the first screen 107 that is farther away from the lens assembly 103, and displays image units B1 and B2 in the second screen 108 that is closer to the lens assembly 103. By adjusting the relative positions of the image units A1 and A2 in the first screen 107, the image units A1 and A2 displayed in the first screen 107 and passing through the second screen 108 are imaged through the lens assembly 103, and are combined to form the image A on the first imaging plane 112. By adjusting the relative positions of B1 and B2 in the second screen 108, the image units B1 and B2 displayed in the second screen 108 are imaged through the lens assembly 103 and are combined to form the image B on the second imaging plane 113. Thus, the imaging device of the present embodiment can display images the same as the binocular 100 in FIG. 1 that actually observes object 109. This combination method does not violate the normal perception of the human eye to observe the object, and can well alleviate the dizziness caused by the inconsistency between the imaging position and the binocular image position.

Preferably, in the first embodiment, the screen assembly 106 comprises a plurality of second screens 108 laminated between the first screen 107 and the lens assembly 103. The image distance of the image unit displayed by each second screen 108 is different. The closer the distance between the second screen 108 and the lens assembly 103, the closer the image unit displayed by the second screen 108 is. When implementing, it is sufficient to adjust the distance of each screen to the same as the imaging distance.

It is understandable that the more screens set in the screen assembly 106, the stronger the sense of hierarchy of the display, and the more rigorous the division of the content displayed on each screen, so that the display effect is better.

It is understandable that the more the number of the second screens 108 and the thickness of the second screen 108 is, the higher its transparency is. The second screen 108 can be a transparent screen.

Preferably, in the first embodiment, the first screen 107 and the second screen 108 are coaxially arranged. The first screen 107 and the second screen 108 are successively arranged in a common axis at the focal plane position of the lens assembly 103.

In the first embodiment, the imaging device further comprises a control unit, through which the first screen 107 and the second screen 108 are controlled to display the image units.

Correspondingly, the embodiment of the present disclosure also provides an imaging method performed in the imaging device. The imaging method comprises:

The first screen 107 and the second screen 108 are controlled to display the image units.

The image units displayed in the transmission area of the lens assembly 103 are merged to form the image.

It is understandable that, in some embodiments, the imaging method also includes a step to split the image to be displayed into image units with different image distances.

In addition to the first embodiment, the second embodiment of the present disclosure provides another imaging device to solve the problem.

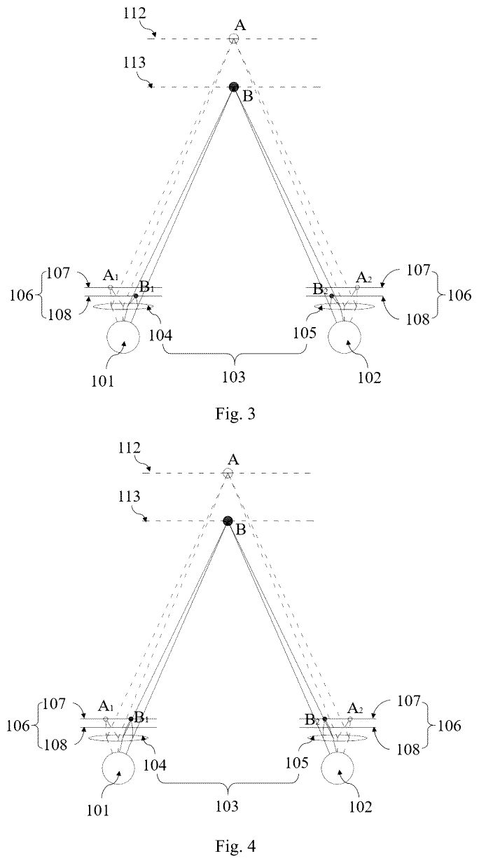

As shown in FIG. 4, in the second embodiment, the imaging device comprises a lens assembly 103 and a screen assembly 106.

The lens assembly 103 comprises a left lens 104 and a right lens 105 corresponding to the left eye 101 and the right eye 102 of a person, respectively. The lens assembly 103 can be designed as a one-piece structure, that is, the left lens 104 and the right lens 105 can be designed as a single piece. However, in order to meet the needs of different interpupillary distance use, the lens assembly 103 usually adopts a split structure. The interpupillary distance can be adjusted with the setting spacing adjustment mechanism to facilitate use. The left lens 104 and the right lens 105 can be made by multiple lenses, so that the left lens 104 and the right lens 105 can independently adjust the focal length to meet the needs of different focal lengths.

The screen assembly 106 is configured to display an image within the transmission region of the lens assembly 103. The binocular 100 can see the image through the transmission region of the lens assembly 103. It is understandable that the images displayed by the screen assembly 106 also correspond to the left eye 101 and the right eye 102, respectively, to simulate the difference in viewing angles.

In the second embodiment of the present disclosure, optionally, the screen assembly 106 may be a split structure which comprises a left eye screen assembly 106 corresponding to the left eye 101 and a right eye screen assembly 106 corresponding to the right eye 102. The screen assembly 106 of split structure can correspond to the lens assembly 103 of the split type, so as to facilitate the adjustment of the interpupillary distance, focal length, or angle of view of the imaging device.

In the second embodiment of the present disclosure, optionally, the screen assembly 106 may be an integral structure, spanning the transmission regions of the left lens 104 and the right lens 105, and displaying images of different viewing angles in the two transmission regions corresponding to the left eye 101 and the right eye 102.

Therefore, those skilled in the art may select the specific requirements of the screen assembly 106 and the lens assembly 103 according to actual needs.

The screen assembly 106 comprises a first screen 107 and a second screen 108. The second screen 108 is arranged between the first screen 107 and the lens assembly 103. In this embodiment, the first screen 107 is a display screen for displaying image units with different image distances of images frame by frame. The second screen 108 is a refractive screen. When the first screen 107 displays image units with different image distances frame by frame, the second screen 108 transmits the image units displayed by the first screen 107, and adjusts the refractive index according to the image distances of the image units.

The light emitted by the first screen 107 first passes through the second screen 108, and then is imaged to its image plane position by the lens assembly 103. The first screen 107 may adopt a conventional microscopic screen. Accordingly, the first screen 107 can adopt a conventional microscopic screen, and the second screen 108 needs to ensure that the image units displayed by the first screen 107 can be transmitted. Therefore, the second screen 108 should be transparency, and preferably, the second screen 108 is a transparent screen.

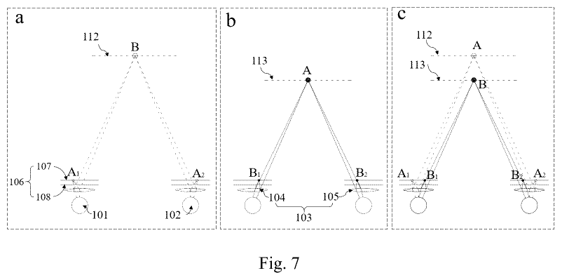

Specifically, please refer to FIG. 4 and FIG. 7. In the second embodiment, the imaging device needs to split the image into a plurality of image units with different image distances to display a stereoscopic image. In order to facilitate understanding, in this embodiment, the image is split into an image unit of a distant view and an image unit of a near view. It is assumed that the image unit of the distant view and the image unit of the near view that are split from the image are respectively represented by two points A and B in FIG. 4, and an image can be formed through the combination of two points A and B.

In the second embodiment, in order to simulate the sense of spatial distance, the imaging device sets the relative position relationship between two points A and B respectively in the left eye screen assembly 106 and the right eye screen assembly 106, so as to simulate the angle of view difference of the binocular 100. As illustrated in FIGS. 4, A1 and B1 simulate the viewing angles of the left eye 101 for A and B, respectively, and A2 and B2 simulate the viewing angles of the right eye 102 for A and B, respectively.

Differing from the first embodiment, in the second embodiment, the image units A1 and A2 of the distant view, or the image units B1 and B2 of the near view are displayed by the first screen 107. In order to avoid the defect that the image units with different image distances illustrated in FIG. 2 is imaged to the same image plane, the first screen 107 displays image units with different image distances frame by frame, each frame displays an image unit. The second screen 108 synchronously adjusts its refractive index based on the image distances of the image units displayed.

In the second embodiment, preferably, the second screen 108 adjusts the refractive index by changing the energizing state. Specifically, the second screen 108 is a twisted nematic (TN) screen, and its liquid crystal characteristics can be used to change the back-focus characteristics of the optical system, so that image units with different image distances are imaged to image planes at different positions.

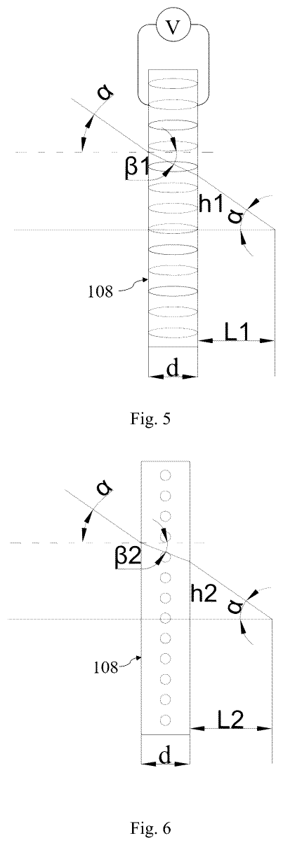

The TN screen can adjust its refractive index by changing energized states when linear polarization light in the same polarization state. Please refer to FIG. 5 and FIG. 6 illustrating the back focus shifts for the TN screen in the power-on and power-off states. Because the TN screen in the power-on and power-off state may adjust its refractive index, and the thickness of the TN screen d is a fixed value, when the light is incident from the same angle, the different refractive angle in the TN screen causes different heights h (e.g. h1 and h2) of the light drop inside the TN screen and different distances L (e.g. L1 and L2) between the final focus imaging point and the TN screen, where L=h/tan α. With this principle, small changes in the back-focus distance can be controlled, so that the imaging distance can be changed.

Accordingly, for image units A1 and A2 of the distant view with a farther image distance and image units B1 and B2 of the near view with a closer image distance, the refractive index can be adjusted by changing the energizing state of the second screen 108 during displaying different frames to image in different image planes. Further, by adjusting the relative positions of A1, A2 and B1, B2 in the first screen 107, the image units A1, A2 can be combined into the image A on the first imaging plane 112, and the image units B1, B2 can be combined into image B on the second imaging plane 113. Moreover, because the image units of different image distances are displayed in different frames, the frames can be smoothly displayed by adjusting the frame rate, so that the human eye can feel the whole image that is stitched together by each image unit displayed. Thus, the imaging device of the present embodiment can display images the same as the binocular 100 in FIG. 1 that actually observes object 109.

Specifically, as illustrated in a in FIG. 7, assuming that the Nth frame displayed in the first screen 107 is the image units A1 and A2 of the distinct view, the second screen 108 (TN screen) is in a power-on state at this moment. According to the optical path imaging principle, the image A of the image units A1 and A2 is positioned at the first imaging plane 112.

As shown in b in FIG. 7, when the first screen 107 is the (N+1)th frame, this frame screen is set to the image unit B1 and B2 of the near view, and the second screen 108 (TN screen) is also switched to the power-off state simultaneously. At this moment, the back focus of the optical system is shifted backward by a short distance, and equivalently, the first screen 107 is shifted forward by a short distance during displaying the Nth frame to decrease the S in the Newtonian imaging formula, thereby causing the imaging distance S′ of B1 and B2 to shorten accordingly. The image B of the image units B1 and B2 is positioned at the second imaging plane 113.

When the Nth frame is switched to the (N+1)th frame, the power-on state of the TN screen is also switched synchronously, and the image units of the left eye 101 and the right eye 102 with angle difference should also be switched synchronously with the same state, so as to finally ensure that the image unit of the distinct view is imaged at the first imaging plane 112 (the distant position), and the image unit of the near field is imaged at the second imaging plane 113 (the near position). Finally, the image distances of the left eye 101 and the right eye 102 are the same as the imaging distance to achieve the effect shown in c in FIG. 7. This effect is similar to the actual observation effect of the human eye shown in FIG. 1. This method will not violate the normal perception of objects by the human eye, and can well alleviate the dizziness caused by the inconsistency between the imaging position and the image position of the binocular eyes.

Preferably, in the second embodiment, the screen assembly 106 comprises a plurality of second screens 108 laminated between the first screen 107 and the lens assembly 103. The refractive index can be adjusted by utilizing the stacking of the second screens 108. It is understandable that the more image units that are split by the stereoscopic image, the stronger the sense of hierarchy and the more rigorous the content division, and the more image units can be adapted by increasing the change of refractive index. Thus, by increasing the frame rate, the first screen 107 displays all image units of the image in a short time, and simultaneously adjusting the refractive index of each second screen 108 to meet the refractive index that each image unit needs, can make the three-dimensional sense stronger. Therefore, it can be understood that the more second screen 108 is set in the screen assembly 106, the more refractive index that can be changed, the stronger the sense of hierarchy that can be displayed, and the more rigorous the content division, so that the display effect is better.

It is understandable that the more second screens 108 set in the screen assembly 106, the stronger the sense of hierarchy of the display, and the more rigorous the division of the content displayed on each screen, so that the display effect is better.

It is understandable that the more the number of the second screens 108 and the thickness of the second screen 108 is, the higher its transparency is. The second screen 108 can be a transparent screen.

Preferably, in the second embodiment, the first screen 107 and the second screen 108 are coaxially arranged. The first screen 107 and the second screen 108 are successively arranged in a common axis at the focal plane position of the lens assembly 103.

In the second embodiment, the imaging device further comprises a control unit, through which the first screen 107 is controlled to display the image unit frame by frame, and the refractive index of the second screen 108 is adjusted according to the image distance of the image unit.

Corresponding to the imaging device of the second embodiment, the embodiment of the present disclosure also provides an imaging method of the imaging device. The method comprises:
controlling the first screen 107 to display the image unit frame by frame, and synchronously adjusting the refractive index of the second screen 108 according to the image distance of the image unit;
merging the image units displayed in the transmission area of the lens assembly 103 to form the image.

It is understandable that, in some embodiments, the imaging method also includes a step to split the image to be displayed into image units with different image distances.

Correspondingly, the embodiment of the present disclosure also provides an augmented or virtual reality apparatus, which comprises an imaging device provided in the embodiments of the present disclosure, and it is understood that the augmented or virtual reality apparatus provided in the embodiment of the present disclosure may have all the technical features and beneficial effects of the aforementioned imaging device, which shall not be repeated herein.

In the above embodiments, the descriptions of each embodiment have their own emphasis, and the part that is not detailed in a certain embodiment may be referred to the relevant descriptions of other embodiments.

The above is a kind of imaging device, method and augmented or virtual reality device provided by the embodiment of the present disclosure in detail, and the principle and embodiment of the present disclosure are elaborated by applying specific examples, and the description of the above embodiment is only used to help understand the technical solution of the present disclosure and its core idea. A person skilled in the art should understand that he may still modify the technical solutions recorded in the foregoing embodiments, or replace some of the technical features therein. And these modifications or substitutions do not make the essence of the corresponding technical solutions out of the scope of the technical solutions of the embodiments of the present disclosure.

1. An imaging device comprising:
a lens assembly;
a screen assembly, comprising a first screen and a second screen between the first screen and the lens assembly, configured to display an image in a transmission area of the lens assembly, wherein the image comprises image units with different image distances;
wherein upon a condition that the second screen is a display screen, the first screen and the second screen display the image units, and the image unit displayed by the first screen is transmitted through the second screen,
upon a condition that the second screen is a refractive screen, the first screen displays each image unit frame by frame, and a refractive index of the second screen is adjusted according to the image distances of the image units.

2. The imaging device of claim 1, wherein the screen assembly comprises a plurality of second screens, and each of the plurality of second screen are stacked between the first screen and the lens assembly.

3. The imaging device of claim 2, wherein upon the condition that the second screen is the display screen, the image distances of the image units displayed by each of the plurality of second screen are different; the closer the second screen to the lens assembly is, the closer the image distance of the displayed image unit is.

4. The imaging device of claim 1, wherein upon the condition that the second screen is the refractive screen, the refractive index of the second screen is adjusted by applying different voltage.

5. The imaging device of claim 4, wherein the second screen is a TN screen.

6. The imaging device of claim 1, wherein the first screen and the second screen are coaxially superimposed.

7. The imaging device of claim 6, wherein the first screen and the second screen are coaxially superimposed and arranged at a focal plane position of the lens assembly.

8. The imaging device of claim 1, wherein the display screen or the refractive screen is a transparent screen.

9. The imaging device of claim 1, further comprising a control unit configured to control the first screen and the second screen to display the image units upon the condition that the second screen is the display screen; or
configured to control the first screen to display the image unit frame by frame, and adjust the refractive index of the second screen according to the image distance of the image unit upon the condition that the second screen is the refractive screen.

10. The imaging device of claim 1, wherein the lens assembly is of an integrated structure.

11. The imaging device of claim 1, wherein the lens assembly is of a split structure.

12. The imaging device of claim 11, wherein the lens assembly comprises a left lens (104) and a right lens (105) both made by multiple lenses.

13. The imaging device of claim 1, wherein the screen assembly is of an integrated structure.

14. (canceled)

15. An augmented or virtual reality device comprising an imaging device, the imaging device comprising:
a lens assembly;
a screen assembly, comprising a first screen and a second screen between the first screen and the lens assembly, configured to display an image in a transmission area of the lens assembly, wherein the image comprises image units with different image distances;
wherein upon a condition that the second screen is a display screen, the first screen and the second screen display the image units, and the image unit displayed by the first screen is transmitted through the second screen,
upon a condition that the second screen is a refractive screen, the first screen displays each image unit frame by frame, and the second screen transmits the image unit, and adjusts a refractive index of the second screen according to the image distance of the image unit.

16. The augmented or virtual reality device of claim 15, wherein the first screen of the imaging device and the second screen of the imaging device are coaxially superimposed.

17. The augmented or virtual reality device of claim 16, wherein the first screen and the second screen are coaxially superimposed and arranged at the focal plane position of the lens assembly.

18. The augmented or virtual reality apparatus of claim 15, wherein the display screen of the imaging device or the refractive screen of the imaging device is a transparent screen.

19. The augmented or virtual reality device of claim 15, wherein the imaging device further comprises a control unit configured to control the first screen and the second screen to display the image units upon the condition that the second screen is the display screen;
configured to control the first screen to display the image unit frame by frame, and adjust the refractive index of the second screen according to the image distance of the image unit upon the condition that the second screen is the refractive screen.

20. The augmented or virtual reality device of claim 15, wherein the lens assembly of the imaging device is of an integrated structure.

21. The augmented or virtual reality device of claim 15, wherein the screen assembly comprises a plurality of second screens, and each of the plurality of second screen are stacked between the first screen and the lens assembly.
